(19) United States
(12) Patent Application Publication
(10) Pub. No.: US 2025/0190708 A1
(43) Pub. Date: Jun. 12, 2025

(54) DIGITAL ASSISTANT IMPROVEMENT SYSTEM

(71) Applicant: SAP SE, Walldorf (DE)

(72) Inventor: Justin MATHEW, Pathanamthitta (IN)

(21) Appl. No.: 18/530,561

(22) Filed: Dec. 6, 2023

(51) Int. Cl. G06F 40/35; H04L 51/02

(52) U.S. Cl. CPC G06F 40/35; H04L 51/02

(57) ABSTRACT

System, method, and various embodiments for a digital assistant improvement system are described herein. An embodiment operates by identifying a plurality of conversation logs between a digital assistant and a user device. A subset of the conversation logs from where a fallback state was detected are identified. One or more intents of the digital assistant are identified, and the subset of conversation logs are categorized in accordance with the one or more intents. A solution to a respective fallback state for a first conversation log is determined, and the solution for improving the digital assistant is provided.

### BACKGROUND

A conversation may include a back-and-forth interaction between two different parties, such as a user and a chatbot. During a conversation, the user will often enter requests or queries to the chatbot, and the chatbot will fulfill those requests. However, there are times when the chatbot is unable to fulfill a user request, and this tends to degrade both the user experience with the chatbot and reduces the utility of the chatbot. This could lead to users to try and find the answers they are seeking through more computationally and resource intensive means, and in some cases, never finding the answers they were seeking at all.

### BRIEF DESCRIPTION OF THE DRAWINGS

The accompanying drawings are incorporated herein and form a part of the specification.

FIG. 1 is a block diagram illustrating example functionality for a digital assistant improvement system (DIS), according to some embodiments.

FIG. 2 is a flowchart illustrating example operations for providing a digital assistant improvement system (DIS), according to some embodiments.

FIG. 3 is example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for providing a digital assistant improvement system.

A conversation may include a back-and-forth interaction between two different parties, such as a user and a chatbot. During a conversation, the user will often enter requests or queries to the chatbot, and the chatbot will fulfill those requests. However, there are times when the chatbot is unable to fulfill a user request, and this tends to degrade both the user experience with the chatbot and reduces the utility of the chatbot. This could lead to users to try and find the answers they are seeking through more computationally and resource intensive means, and in some cases, never finding the answers they were seeking at all.

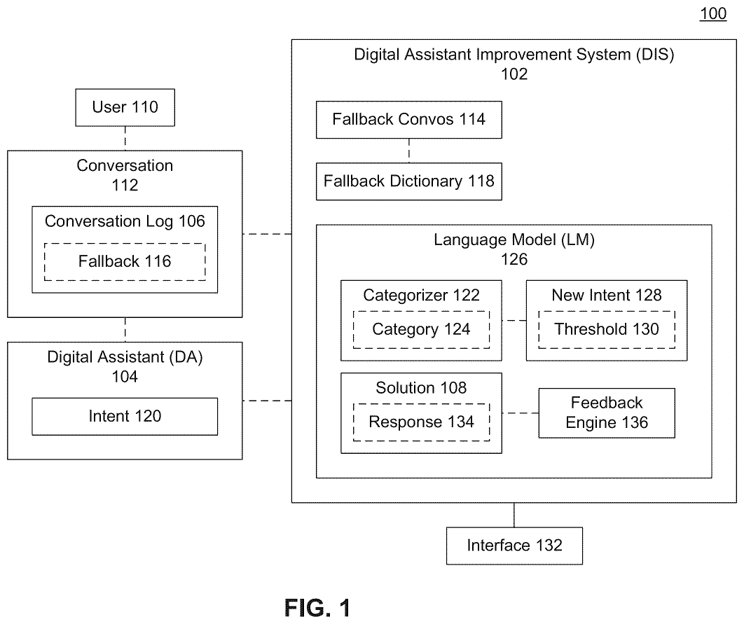

FIG. 1 is a block diagram 100 illustrating example functionality for a digital assistant improvement system (DIS) 102, according to some embodiments. DIS 102 may help improve the responsiveness and effectiveness of a digital assistant (DA) 104. In some embodiments, DIS 102 may monitor or review a conversation log 106, to identify whether the DA 104 was unable to assist a user 110 in some request or query. Based on this review, DIS 102 may identify, generate, propose a solution 108 to improve the functionality of the DA 104. Whether or not a developer accepts or rejects the solution 108 may be received as feedback that may be used to improve the efficiency of processing subsequent conversation logs 106 and generating subsequent solutions 108, as well as improving the functionality of the DA 104.

In some embodiments, a user 110 may connect to a digital assistant (DA) 104. In some embodiments, the user 110 may use a device such as a mobile phone, remote control, laptop, tablet, SMART television, internet of things (IoT), or other computing device that enables communications with DA 104. In other embodiments, the user 110 may directly interface with DA 104 through audible communications, e.g., by speaking requests directly into a microphone of DA 104 (e.g., which may also include a speaker for communicating with the user 110).

In some embodiments, DA 104 may be a software application that allows a user to use natural language through text or voice to communicate requests, commands, or queries to DA 104. In responding to these requests, DA 104 may be configured to mimic human conversations.

In some embodiments, DA 104 may be connected to or utilize an artificial intelligence or machine learning system, and/or one or more data repositories it may access, which may include the Internet, to answer user queries or respond to user requests or entries. In some embodiments, DA 104 may include a chatbot. In some embodiments, DA 104 may be a standalone device to which the user issues voice or other commands. In other embodiments, DA 104 may be integrated into any computing device, mobile phone, or IoT device, or may be accessible via a website or app. DA 104 may be communicatively coupled to one or more other systems (not shown) that may be utilized in responding to user commands or queries. In some embodiments, DA 104 may include a monitor or other visual interface and/or a speaker and a microphone by which to communicate with user 110 and receive communications from user.

The communications between DA 104 and user 110 may include visual and/or auditory communications, and may include queries, responses to queries, and the sending of files or other data back and forth. These communications may be referred to as a conversation 112. In some embodiments, conversation 112 may be visual (e.g., performed via a user interface or application), or audible.

In some embodiments, a conversation log 106 may capture, include a summary, or a transcript of interactions between input received from user 110 directed to DA 104 and input from DA 104 directed to user 110. These communications may include audible and/or textual communications. With audible communications, the conversation log 106 may include a sound-to-text capture of the words or sounds received from the user 110, as well as the text or transcript of what was audibly output by DA 104.

In some embodiments, the conversation log 106 may be captured by a standalone system that is separate from, but configured to communicate with DIS 102. DIS 102 may then receive or retrieve one or more conversation logs 106 from a storage system. In some embodiments, DIS 102 may be integrated with DA 104, and DIS 102 may be configured to capture and store conversation logs 106.

For simplicity, the example of FIG. 1 illustrates a single conversation log 106, conversation 112, user 110, and DA 104. However, it is understood that the DIS 102 there may any variety of arrangements. For example, there may be multiple different users 110 communicating with multiple different DAs 104, that have engaged in various conversations 112, any number of which may have occurred in parallel, and that are captured across multiple conversation logs 106.

In many of the examples described herein, DIS 102 is described to have access to multiple conversation logs 106 (e.g., which may be between different users 110 and/or DAs 104), and which may be stored in and/or accessed across one or more repositories. As such, conversation log 106 may be illustrative of multiple conversation logs 106, DA 104 may be illustrated of different DAs 104 interacting with different users 110 via different conversations 112. The terms conversation log 106 and conversation logs 106, and the terms user 110 and user device, may be used interchangeably.

In some embodiments, DIS 102 may receive or retrieve a set of multiple conversation logs 106. Each conversation log 106 may include the text of the conversation between a single DA 104, or the same version of a DA 104, and a user 110. For example, conversation logs 106 may include 1000 logs between version A of a DA 104, with various instances executed across various computing devices, and different users 110 who were interacting with version A of DA 104, at least some of which may have occurred simultaneously.

In some embodiments, conversation logs 106 may include transcripts of communications across different versions of DA 104, which may be operating across one or more different computing devices which may be networked together in a cloud environment, or may be standalone devices. If there are different versions of DA 104, in some embodiments, DIS 102 may group the conversation logs 106 by the version and process each version separately as described herein. In other embodiments, the conversation logs across multiple or different versions may be processed together and the solution 108 may be applied to the multiple or different versions of DA 104 that were processed together. The versions of DA 104 may include software, firmware, model numbers, or other version identifiers. In some embodiments, the conversation logs 106 may indicate which version of DA 104 is communicating with a user 110.

As noted above, there may be times when a DA 104 is unable to fulfill a user request, command, or query. This condition may be referred to as a fallback 116. Fallback 116 may include any condition indicating that DA 104 was unable to fulfill one or more requests from a user 110.

In some embodiments, fallback 116 may be different from an error condition (such as an exception or crash). For example, an error condition may indicate a failure in computational or hardware processing, while a fallback 116 may indicate a logical response from the DA 104 that was deemed unsatisfactory to the user 110. In some embodiments, fallback 116 may include error conditions.

In some embodiments, DIS 102 may use a fallback dictionary 118 to identify which conversation logs 106 include a fallback 116. Fallback dictionary 118 may include one or more words or phrases that indicate that a fallback 116 has occurred. In some embodiments, the phrases from fallback dictionary 118 may include a standard response from DA 104 when it is unable to fulfill a request, such as “I'm sorry, I cannot help you with that,” or “I'm sorry, I do not have that answer”. In some embodiments, the phrase may include simply “I'm sorry” which may be able to capture a variety of different statements that indicate that the DA 104 cannot fulfill a request from user 110.

In some embodiments, fallback dictionary 118 may include phrases provided by the user 110 (as included in the conversation log 106), which may indicate the user is displeased with the response from DA 104. These phrases may include curse words, or other indications of displeasure. In some embodiments, the conversation logs 106 may indicate which input was received from DA 104, and which input was received from a user 110.

In some embodiments, DIS 102 may identify a set of fallback convos 114 from the set of conversation logs 106. The fallback convos 114 may include those conversation logs 106 in which a fallback 116 was identified or detected.

In some embodiments, a DA 104 may be configured to fulfill or process an intent 120. Intent 120 may include an area of service or type of request that the DA 104 is configured to respond to and fulfill. For example, if DA 104 is configured to help users 110 with medical issues, examples of intent 120 may include: prescription refill, order status, refund request, new doctor appointments, travel details (e.g., to a hospital or pharmacy), etc. Then for example, user 110 may interact with DA 104 to get their prescription medication refilled and may submit a variety a requests or queries such as: can I get my prescription refilled? When do I need to get my prescription refilled? I ran out of my prescription, etc. DA 104 may be configured to respond to these and other queries as part of the prescription refill intent 120.

In some embodiments, a single DA 104 may be configured to fulfill a single intent 120, or multiple different intents 120. For simplicity, only a single intent 120 is illustrated, however it is understood that the DA 104 may be configured to fulfill multiple intents 120. In some embodiments, a categorizer 122 may determine into which category 124 each fallback convo 114 is to be categorized or grouped. In some embodiments, a category 124 may correspond to an intent 120. For example, DA 104 may be configured to help users 110 with medical issues, and may include three intents 120: 1) medicine or prescription refill 2) transportation and 3) doctor appointments. The fallback convos 114 may include interactions from users 110 that are directed to any of the intents 120, and/or may include other requests not covered by the existing intents 120.

In some embodiments, categorizer 122 may be part of integrated with or utilize a language model (LM) 126. LM 126 may include a pre-trained transformer or artificial intelligence system that is configured or designed to perform various tasks based on provided input or prompts. In some embodiments, LM 126 may be a large-scale language model (LLM). LLM may include a larger number of model parameters and more robust training data relative to a general LM.

While LM 126 may not require a particular format of input or prompt, in some embodiments DIS 102 may generate a prompt to be in a particular format that is easy for LM 126 to understand, process, and produces the desired output or results as described herein. In some embodiments, DIS 102 may generate a prompt template as a result of repeated trials and tests with data and output by LM 126, tweaked in a format that is used to produce the intended output.

Though illustrated as being integrated within DIS 102, in some embodiments, in some embodiments, LM 126 may be a standalone system to which DIS 102 has access and provides the identified and requested input to in form of a prompt which is processed by LM 126, and which may then provide a result to DIS 102.

In some embodiments, LM 126 may be configured to read, process, and analyze conversation logs 106 and/or fallback convos 114 in the manners described herein. For example, LM 126 may be configured to identify a set of fallback convos 114 from the conversation logs 106, based on the identification of fallbacks 116 based on the fallback dictionary 118.

With regards to performing categorization, the LM 126 may be able to read the text of various fallback convos 114 to identify to which category 124 (related to which intent(s) 120, if any), the various fallback convos 114 are to be grouped. In some embodiments, LM 126 may sort, group or mark the various fallback convos 114 based on their categorization. For example, each conversation log may include conversation identifier (ID). The fallback convos 114 may include a list, array, or other collection of those conversation IDs in which a fallback 116 was detected.

As an example, to identify which of the existing intents 120, if any, may need to be updated or improved to address the fallback 116 in the fallback convos 114, categorizer 122 may divide the fallback convos 114 into one of four categories, which may include any of the existing three intents 120 of 1) medicine or prescription refill 2) transportation and 3) doctor appointments (in continuing the example above), or a fourth category of “other”, indicating interactions or fallback convos 114 that do not fall into any one of the existing intents 120. In other embodiments, if there are five intents 120, then categorizer 122 may use six possible categories 124. In some embodiments, a developer may provide a list of the existing intents 120 to DIS 102.

In continuing the example above, LM 126 may determine whether a new intent 128 is to be recommended or created for DA 104 based on the fourth “other” category 124. For example, LM 126 may process the text of the ‘other’ fallback convos 114 to identify any patterns in the requests or queries with regard to subject matter or entries by user 110, and if there is a pattern that is identified that exceeds a threshold 130 number of occurrences across the fallback convos 114, then the pattern may be recommended as a new intent 128.

For example, there may be 100 fallback convos 114 in the ‘other’ category 124, and LM 126 may determine that 21 of those fallback convos 114 are related to medical device issues (which is not related to an existing intent 120) based on the text of what the user 110 is inputting for the DA 104. LM 126 may further determine that the threshold 130 for a new intent 128 is 20, in which case, LM 126 may identify medical device as a new intent 128. The other 79 fallback convos 114 that remain in the other category 124 may not fit into any detectable pattern or any pattern that exceeds threshold 130.

In some embodiments, threshold 130 may be a batch threshold (e.g., for a particular set of fallback convos 114 that are being processed together), or a historical threshold (e.g., over a course of a year, or since a particular date that may be applied across multiple batches of fallback convos 114). If threshold 130 is a historical threshold, the uncategorized other fallback convos 114 may be maintained and reprocessed during future processing to determine if the historical threshold 130 has been exceeded.

In some embodiments, LM 126 may generate a solution 108. Solution 108 may include any indication as to what may be done to improve the functionality of DA 104 with respect to any of the detected fallbacks 116 in the fallback convos 114. In some embodiments, solution 108 may include an indication as to which fallback convos 114 belong to which categories 124, in some embodiments, solution 108 may include a pointer, link, or transcript of the relevant fallback convos 114. From this solution 108, a developer may quickly see and decide which fallback convos 114 to use to address or improve DA 104.

In some embodiments, solution 108 may include a set of phrases extracted from the fallback convos 114 (as entered by user 110) which resulted in a fallback response 116 from DA 104 (e.g., such as, “I'm sorry I cannot help you with that” or “I do not have that answer”). In some embodiments, while threshold 130 may be applied to new intents 128, fallback conditions identified with existing intents 120 may not include any such threshold 130, or may include a lower threshold 130, as it may be advantageous to continue improving the functionality of DA 104 with regard to existing intents 120.

In some embodiments, solution 108 may include an indication of a new intent 128 to recommend to generate for DA 104, because a set of fallback convos 114 has exceeded threshold 130. As noted above, the solution 108 may include links, text, or pointers to the relevant fallback convos 114 so that the developer may further investigate the appropriate action.

In some embodiments, DIS 102 may provide the solution 108 to a developer via an interface 132. Interface 132 may include any electronic communication medium, including, but not limited to a text message, email, visual user interface, or auditory interface.

Upon receiving solution 108, a developer may have the option to accept, reject, or postpone the solution 108. Accepting the solution 108 may be indication that the developer will or has implement the recommended solution 108 into DA 104, rejection the solution 108 may be an indication the developer will not implement or does not agree with the solution 108. Postponing may be an indication that the developer is not ready to either accept or reject the solution 108. The developer may then provide their response 134 (e.g., acceptance, rejection, postponement), via interface 132.

Response 134 may indicate how the developer responded to solution 108. In some embodiments, if the developer does not respond to a solution within a threshold period of time, DIS 102 may automatically register a postponement response as response 134.

In some embodiments, a feedback engine 136 may receive the response 134 and use the response 134 to improve the processing of DIS 102 and/or LM 126. For example, if the solution 108 proposes a new intent 128 (such as medical devices), and response 134 indicates a rejection, feedback engine 136 may log that the developer (or team) is not interested in creating a new intent 128 for medical devices.

Then, for example, in later processing of future fallback convos 114, even if there are medical device fallback convos 114 that exceed threshold 130, DIS 102 may not recommend a new intent 128 for the medical device intent (because of the developer's prior rejection of medical device as a new intent 128). In some embodiments, the medical device fallback convos 114 may be logged into another category 124 of rejected intents, which may be provided as part of solution 108. Then, for example, the developer may see that they have rejected the medical device intent, but that there are more medical device requests and the developer may then have a new opportunity to accept, reject, or postpone this solution 108. In some embodiments, a rejection in response 134 may cause LM 126 to increase the threshold 130 for future solutions 108 recommending the same new intent 128.

If the response 134 includes a postponement, then feedback engine 136 may not change the processing of DIS 102 or LM 126, and may continue processing similarly to how it was processing prior to response 134. In some embodiments, if a similar solution 108 (that was proposed before and postponed) is proposed again, solution 108 may include a count or indication of how many times the solution 108 has been proposed.

If a new intent 128 is accepted in response 134, then future processing may include the new intent 128 as a new category 124. In some embodiments, the new category 124 may be a tentative new category 124 until DIS 102 receives further confirmation that the DA 104 has actually been upgraded or updated with the new intent 128. For example, the developer may accept the medical device new intent 128, however prior to DA 104 being upgraded with the medical device intent, DIS 102 may perform a new round processing on new fallback convos 114. As such, any new fallback convos 114 regarding medical devices may be logged into the tentative new category, which may make it clear to the develop that this intent 120 was previously accepted. When the DA 104 has been upgraded with the medical device intent, the developer may update an intent document or otherwise communicate the upgraded intent to DIS 102.

In some embodiments, a request from user 110 may fall into two different intents 120, and because DA 104 did not understand how to process the request, DA 104 may respond with a fallback response 116. For example, the three intents 120 may be: 1) medicine or prescription refill 2) transportation to doctor appointments and 3) setting or updating doctor appointments. If a user 110 requests a ride to refill a prescription, this may fall in either intent 1 or intent 2, and may cause a fallback 116. Then, for example, DIS 102 may identify this and indicate that in further processing this request should fall into the transportation intent, this may be proposed as part of solution 108. In some embodiments, DIS 102 may have access to the logical processing of DA 104, and upon acceptance of this solution 108, DIS 102 may update DA 104, such that during a subsequent processing, a similar request may be processed successfully by DA 104.

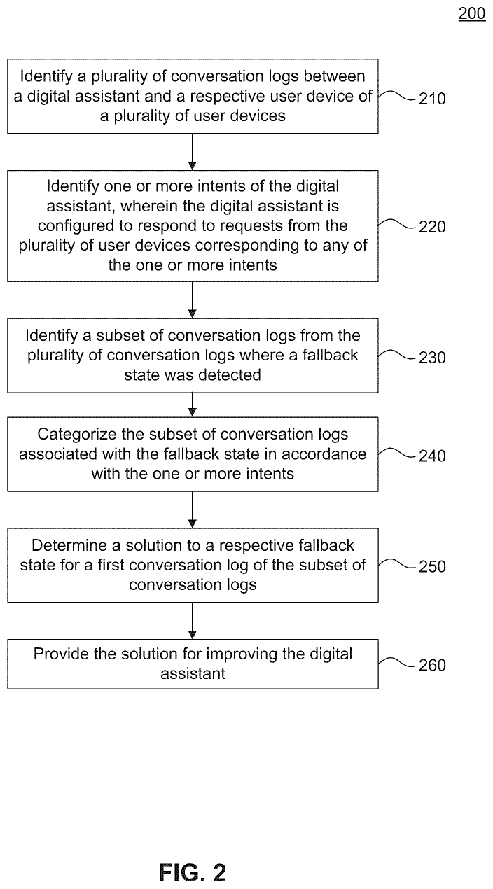

FIG. 2 is a flowchart 200 illustrating example operations for providing a digital assistant improvement system (DIS) 102, according to some embodiments. Method 200 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 2, as will be understood by a person of ordinary skill in the art. Method 200 shall be described with reference to FIG. 1.

In 210, a plurality of conversation logs, between a digital assistant and a respective user device of a plurality of user devices, are identified. For example, DIS 102 may identify or have access to a plurality of conversation logs 106 between a digital assistant 104 and a user device 110. Each conversation log 106 may include text, speech converted to text, and any other data that was exchanged between the digital assistant 104 and the respective user device 110.

In 220, one or more intents of the digital assistant are identified. For example, DA 104 may be configured to respond to one or more intents 120. An intent 120 may include any request or set of requests or queries to which the DA 104 is configured to respond, from any of the different users 110.

In 230, a subset of conversation logs from the plurality of conversation logs where a fallback state was detected are identified. For example, DIS 102 may identify a fallback 116 in a subset of the conversation logs 106, and mark, save, or group those identified conversation logs 106 as fallback convos 114. The fallback 116 may include a response by the digital assistant 104 indicating an inability to fulfill a request from the respective user 110 or user device.

In 240, the subset of conversation logs associated with the fallback state are categorized in accordance with the one or more intents. For example, categorizer 122 may separate the fallback convos 114 into various categories 124, each category 124 corresponding to a different intent 120. In some embodiments, there may be an additional category 124 for any fallback convos 114 that cannot be categorized or classified into an existing category 124, or that may span multiple categories 124. In some embodiments, LM 126 may identify one or more new intents 128 for these uncategorized fallback convos 114, if there are enough to exceed a threshold 130.

In 250, a solution to a respective fallback state for a first conversation log of the subset of conversation logs is determined. For example, if there is a fallback convo 114 that falls into multiple intents 120, LM 126 may identify a preferred intent 120 into which the categorize fallback convo 114. Or, for example, if a query for a first intent 120 was unable to be processed due to specific language used by the user 110, the solution 108 may include expanding the training of the DA 104 to associate the new language with the identified intent 120.

In 260, the solution for improving the digital assistant is provided. For example, the solution 108 may be provided via an interface 132 which a developer may accept or reject. If the developer accepts the solution 108, the developer may the implement the solution 108 into DA 104. In some embodiments, a simple solution, such as updating or expanding the terminology the DA 104 associates with a specific intent 120, or how the DA responds to a particular query, the DIS 102 may incorporate those changes in DA 104. The solution 108 may be intended to improve the processing of the DA 104 during a subsequent execution, such that the fallback state 116 does not occur.

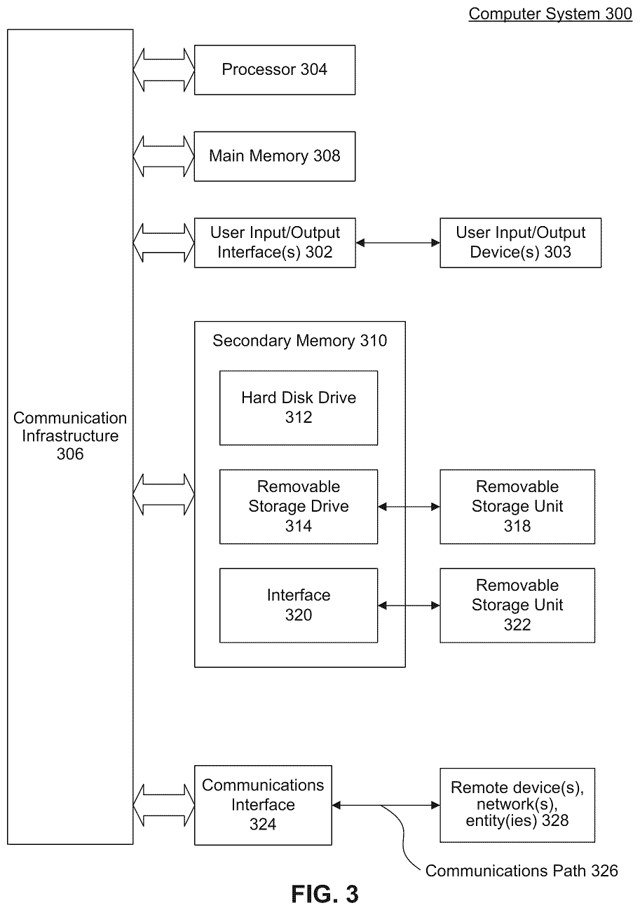

Various embodiments may be implemented, for example, using one or more well-known computer systems, such as computer system 300 shown in FIG. 3. One or more computer systems 300 may be used, for example, to implement any of the embodiments discussed herein, as well as combinations and sub-combinations thereof.

Computer system 300 may include one or more processors (also called central processing units, or CPUs), such as a processor 304. Processor 304 may be connected to a communication infrastructure or bus 306.

Computer system 300 may also include user input/output device(s) 303, such as monitors, keyboards, pointing devices, etc., which may communicate with communication infrastructure 306 through user input/output interface(s) 302.

One or more of processors 304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 300 may also include a main or primary memory 308, such as random access memory (RAM). Main memory 308 may include one or more levels of cache. Main memory 308 may have stored therein control logic (i.e., computer software) and/or data.

Computer system 300 may also include one or more secondary storage devices or memory 310. Secondary memory 310 may include, for example, a hard disk drive 312 and/or a removable storage device or drive 314. Removable storage drive 314 may be a floppy disk drive, a magnetic tape drive, a compact disk drive, an optical storage device, tape backup device, and/or any other storage device/drive.

Removable storage drive 314 may interact with a removable storage unit 318. Removable storage unit 318 may include a computer usable or readable storage device having stored thereon computer software (control logic) and/or data. Removable storage unit 318 may be a floppy disk, magnetic tape, compact disk, DVD, optical storage disk, and/any other computer data storage device. Removable storage drive 314 may read from and/or write to removable storage unit 318.

Secondary memory 310 may include other means, devices, components, instrumentalities or other approaches for allowing computer programs and/or other instructions and/or data to be accessed by computer system 300. Such means, devices, components, instrumentalities or other approaches may include, for example, a removable storage unit 322 and an interface 320. Examples of the removable storage unit 322 and the interface 320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 300 may further include a communication or network interface 324. Communication interface 324 may enable computer system 300 to communicate and interact with any combination of external devices, external networks, external entities, etc. (individually and collectively referenced by reference number 328). For example, communication interface 324 may allow computer system 300 to communicate with external or remote devices 328 over communications path 326, which may be wired and/or wireless (or a combination thereof), and which may include any combination of LANs, WANs, the Internet, etc. Control logic and/or data may be transmitted to and from computer system 300 via communication path 326.

Computer system 300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 300 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 300, main memory 308, secondary memory 310, and removable storage units 318 and 322, as well as tangible articles of manufacture embodying any combination of the foregoing. Such control logic, when executed by one or more data processing devices (such as computer system 300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method comprising:
identifying a plurality of conversation logs between a digital assistant and a respective user device of a plurality of user devices, wherein each of the plurality of conversation logs include text that was exchanged between the digital assistant and the respective user device;
identifying one or more intents of the digital assistant, wherein the digital assistant is configured to respond to requests from the plurality of user devices corresponding to any of the one or more intents;
identifying a subset of conversation logs from the plurality of conversation logs where a fallback state was detected, wherein the fallback state comprises a response by the digital assistant indicating an inability to fulfill a request from the respective user device;
categorizing the subset of conversation logs associated with the fallback state in accordance with the one or more intents;
determining a solution to a respective fallback state for a first conversation log of the subset of conversation logs, wherein the first conversation log was categorized into a first intent of the one or more intents; and
providing the solution for improving the digital assistant, wherein the digital assistant incorporating the solution is configured to produce a successful execution rather than the fallback state in a subsequent execution.

2. The method of claim 1, wherein the conversation logs include a textual transcript of audible exchanges of a conversation.

3. The method of claim 1, wherein the fallback state comprises a predetermined output by the digital assistant.

4. The method of claim 3, wherein the identifying the subset comprises detecting the predetermined output within each conversation log in the subset of conversation logs.

5. The method of claim 1, wherein at least the categorizing and the determining are performed by a language model incorporating one of artificial intelligence or machine learning technologies.

6. The method of claim 1, further comprising:
receiving a rejection to the solution, wherein upon a subsequent processing of a conversation log, the solution is not provided in response to the respective fallback state.

7. The method of claim 1, wherein the determining the solution comprises:
identifying a new intent to incorporate into the digital assistant; and
wherein the providing comprises providing a notification that a new intent has been identified.

8. The method of claim 7, wherein the identifying the new intent comprises:
identifying a new subset of the subset of conversation logs comprising a plurality of conversation logs that could not be categorized in accordance with the one or more intents; and
from the new subset, identifying a new intent based on a threshold number of conversation logs including one or more key words associated with the new intent.

9. A system comprising:
a memory; and
at least one processor coupled to the memory and configured to perform operations comprising:
identifying a plurality of conversation logs between a digital assistant and a respective user device of a plurality of user devices, wherein each of the plurality of conversation logs include text that was exchanged between the digital assistant and the respective user device;
identifying one or more intents of the digital assistant, wherein the digital assistant is configured to respond to requests from the plurality of user devices corresponding to any of the one or more intents;
identifying a subset of conversation logs from the plurality of conversation logs where a fallback state was detected, wherein the fallback state comprises a response by the digital assistant indicating an inability to fulfill a request from the respective user device;
categorizing the subset of conversation logs associated with the fallback state in accordance with the one or more intents;
determining a solution to a respective fallback state for a first conversation log of the subset of conversation logs, wherein the first conversation log was categorized into a first intent of the one or more intents; and
providing the solution for improving the digital assistant, wherein the digital assistant incorporating the solution is configured to produce a successful execution rather than the fallback state in a subsequent execution.

10. The system of claim 9, wherein the conversation logs include a textual transcript of audible exchanges of a conversation.

11. The system of claim 9, wherein the fallback state comprises a predetermined output by the digital assistant.

12. The system of claim 11, wherein the identifying the subset comprises detecting the predetermined output within each conversation log in the subset of conversation logs.

13. The system of claim 9, wherein at least the categorizing and the determining are performed by a language model incorporating one of artificial intelligence or machine learning technologies.

14. The system of claim 9, the operations further comprising:
receiving a rejection to the solution, wherein upon a subsequent processing of a conversation log, the solution is not provided in response to the respective fallback state.

15. The system of claim 9, wherein the determining the solution comprises:
identifying a new intent to incorporate into the digital assistant; and
wherein the providing comprises providing a notification that a new intent has been identified.

16. The system of claim 15, wherein the identifying the new intent comprises:
identifying a new subset of the subset of conversation logs comprising a plurality of conversation logs that could not be categorized in accordance with the one or more intents; and
from the new subset, identifying a new intent based on a threshold number of conversation logs including one or more key words associated with the new intent.

17. A non-transitory computer-readable medium having instructions stored thereon that, when executed by at least one computing device, cause the at least one computing device to perform operations comprising:
identifying a plurality of conversation logs between a digital assistant and a respective user device of a plurality of user devices, wherein each of the plurality of conversation logs include text that was exchanged between the digital assistant and the respective user device;
identifying one or more intents of the digital assistant, wherein the digital assistant is configured to respond to requests from the plurality of user devices corresponding to any of the one or more intents;
identifying a subset of conversation logs from the plurality of conversation logs where a fallback state was detected, wherein the fallback state comprises a response by the digital assistant indicating an inability to fulfill a request from the respective user device;
categorizing the subset of conversation logs associated with the fallback state in accordance with the one or more intents;
determining a solution to a respective fallback state for a first conversation log of the subset of conversation logs, wherein the first conversation log was categorized into a first intent of the one or more intents; and
providing the solution for improving the digital assistant, wherein the digital assistant incorporating the solution is configured to produce a successful execution rather than the fallback state in a subsequent execution.

18. The non-transitory computer-readable medium of claim 17, wherein the conversation logs include a textual transcript of audible exchanges of a conversation.

19. The non-transitory computer-readable medium of claim 17, wherein the fallback state comprises a predetermined output by the digital assistant.

20. The non-transitory computer-readable medium of claim 19, wherein the identifying the subset comprises detecting the predetermined output within each conversation log in the subset of conversation logs.
